(19) United States
(12) Patent Application Publication
(10) Pub. No.: US 2018/0164970 A1
(43) Pub. Date: Jun. 14, 2018

(54) AUTOMATED OPTIMIZATION OF USER INTERFACES BASED ON USER HABITS

(71) Applicant: RF Digital Corporation, Hermosa Beach, CA (US)

(72) Inventor: Hendrik Volkerink, Santa Clara, CA (US)

(73) Assignee: RF Digital Corporation, Hermosa Beach, CA (US)

(21) Appl. No.: 15/841,504

(22) Filed: Dec. 14, 2017

Related U.S. Application Data
(60) Provisional application No. 62/433,844, filed on Dec. 14, 2016.

(51) Int. Cl. G06F 3/0484; G06F 9/44

(52) U.S. Cl. CPC G06F 3/0484; G06F 9/4443

(57) ABSTRACT

The present disclosure describes automated optimization of user interfaces that can be customized to the needs of a particular user or group of users based on the user habits while using a mobile or other app. The available paths within an app, each of which represents a sequence of user interactions and screens that lead to a respective result, can be modified dynamically in an automated fashion based on the user's habits such that the interface presented to the particular user (or group of users) is tailored to the individual's or group's particular habits.

### TECHNICAL FIELD

The present disclosure relates to automated optimization of user interfaces based on user habits.

### BACKGROUND

The internet of things (“IoT”) refers to the inter-networking of physical devices, automobiles, buildings and other objects that are embedded with electronics, software and network connectivity to enable the objects to collect and exchange data. When IoT is combined with sensors and actuators, the technology can encompass smart homes, smart grids, intelligent transportation and the like. Each object is uniquely identifiable through its embedded computing system, but also can inter-operate within the existing Internet infrastructure. The interconnection of these embedded devices is expected to usher in automation in a wide range of fields.

Home automation or smart home systems, for example, can involve the control and automation of lighting, heating, ventilation, air conditioning, appliances, and/or security systems in a home, office or other setting. The systems can include switches and sensors coupled to a central hub, sometimes called a “gateway,” from which the system is controlled by a user interface implemented as part of a wall-mounted terminal, a smart phone, a tablet computer or an Internet or other network interface. Home automation software thus can facilitate control of common appliances found, for example, in a home or office, such as lights, heating and ventilation equipment, access control, sprinklers, and other devices.

As mobile devices with advanced computing ability and connectivity have become increasingly prevalent, there has been in increase in the development and adoption of specialized programs (“apps”) that run on such devices and that provide a user interface to the outside world. Such apps can provide for scheduling tasks, such as turning appliances on at the appropriate times, and event handling (e.g., turning on lights when motion is detected).

### SUMMARY

The present disclosure describes an improvement to computer technology and, in particular, describes automated optimization of user interfaces that can be customized to the needs of a particular user or group of users based on the user habits. As described in greater detail below, the available paths within an app, each of which represents a sequence of user interactions and screens that lead to a respective result, can be modified dynamically in an automated fashion based on the user's habits such that the interface presented to the particular user (or group of users) is tailored to the individual's or group's particular habits.

In one aspect, for example, the present disclosure describes a method that includes monitoring, by a computing system, user interactions with an application operable to present an interactive user interface, automatically modifying, by the computing system, a model of the interactive user interface based on the monitoring, automatically rendering, by the computing system, screen constructs based on the modifying, and automatically integrating, by the computing system, the screen constructs into user interface templates for presentation during a subsequent user session with the application.

Some implementations include one or more of the following features. For example, in some instances, the model of the interactive user interface is a directed graph composed of nodes and edges. Modifying the model can include eliminating one or more of the edges, combining multiple ones of the edges into a single edge, and/or expanding one of the edges into multiple edges.

In some cases, the method includes presenting, during the subsequent user session, a modified user interface based on the screen constructs integrated into the user interface templates.

In accordance with another aspect, a system includes a user habits monitor engine operable to monitor user interactions with an application that is operable to present an interactive user interface, a user interface graph efficiency engine operable to modify a model of the interactive user interface based on monitoring by the user habits monitor engine, and a rendering and integrating engine operable to render screen constructs based on modifying of the model by the user interface graph efficiency engine, and to integrate the screen constructs into user interface templates for presentation during a subsequent user session with the application.

In some implementations, the model of the interactive user interface is a directed graph composed of nodes and edges, and the user interface graph efficiency engine is operable to perform at least one of the following: modify the model by eliminating one or more of the edges, modify the model by combining multiple ones of the edges into a single edge, and/or modify the model by expanding one of the edges into multiple edges.

In some instances, the system is operable to present on a display, during the subsequent user session, a modified user interface based on the screen constructs integrated into the user interface templates.

Other aspects, features and advantages will be readily apparent from the following detailed description, the accompanying drawings and the claims.

### BRIEF DESCRIPTION OF THE DRAWINGS

FIG. 1 shows an example of a system for automated optimization of a user interface based on user habits.

FIG. 2 illustrates an example of a user interface graph.

FIGS. 3A and 3B illustrate examples of intuitive relationships graphs.

FIG. 4 illustrates an example of a method for automated optimization of a user interface based on user habits.

FIG. 5 illustrates an example of a process for calculating the efficiency of a user interface graph.

FIGS. 6A-6F illustrate an example of automated optimization of a user interface based on user habits.

### DETAILED DESCRIPTION

The present disclosure describes an improvement to computer technology and, in particular, describes automated optimization of user interfaces that are customized to the needs of a particular user or group of users. The techniques described in greater detail below can help optimize the user interface for a software app on a mobile or other device 10 by dynamically changing the screens, or sequence of screens, presented to the user on a display 12 in a manner that is customized for the individual user or a group of users based on the past habits of the individual user or group while using the app.

A typical app, which can be stored, for example, on the device 10, may present a main screen or home screen to the user upon initiation. The main screen may provide the user with multiple options from which to choose. The options may take the form, for example, of a drop-down menu, or selectable buttons or icons appearing on the device's display. Depending on the type of device on which the app is being executed, a user may be able to interact with the app in one or more ways. Examples of user interactions including tapping on or swiping across the device's touch screen, pressing one or more keys on the device's keyboard or providing a voice command that can be recognized by the device. The display 12, the screens presented by the app on the display 12, and other features of the device that allow the user to interact with the app (e.g., provide input to the app) form an interactive user interface 14. The app may respond to a user's selection, for example, by presenting another screen that contains different or additional information.

In some instances, the user may be find it necessary, for example, to traverse a particular path within the app by interacting with multiple screens before reaching the screen that presents the particular information of interest. Depending on the available functionality of the app, there may be many different paths within the app the user potentially can traverse. Further, a given user might never traverse particular ones of the available paths or may do so infrequently. In other cases, the user may find that he is traversing back and forth between the same subset of screens before successfully locating information presented by a particular screen of interest. The latter situation is likely to be frustrating to users.

In order to enhance the user experience, the user's habits in using the app can be monitored and analyzed. The available paths within the app, each of which represents a sequence of user interactions and screens that lead to a respective result, can be modified dynamically in an automated fashion based on the user's habits. The changes then can be incorporated automatically to provide an updated user interface for the particular app.

To implement automated optimization of the user interface 14, a model of paths indicative of potential user interactions with the app and the resulting screens displayed in response to each user interaction can be stored, for example, as a directed graph. The directed graph, which can be referred to as a user interface graph 20, can be stored, for example, in memory that is part of a cloud-based, or hosted, computing system. Cloud-based, or hosted, computing generally involves executing applications via a web browser, and obtaining information for the app from a remote server system or service and involves the delivery of computing as a service whereby shared resources, software, and information are provided to computers and other devices as a utility over a network such as the Internet. Thus, cloud computing can make use of a set of pooled computing resources and services delivered over the World Wide Web. In some instances, the directed graph 20 may be stored in memory other than in the cloud (e.g., locally in the device's 10 own memory).

The user interface graph 20 describes all potential user experiences and options with the app and can be composed of nodes and edges. Each node of the graph represents a certain user interface state, and each edge represent a potential user interaction with the user interface 14. A user interface state does not necessarily represent a system state; in some instances, the user interface state can be another user interface screen or an actual inter-activity event (e.g., an input or output). A navigation node, for example, represents a new screen with various interaction options, whereas an interaction node represents an interaction. Thus, a node can represent a visual screen or a screen in the process of executing an interaction. Further, the user interface can be orthogonal to the actual functioning of the system.

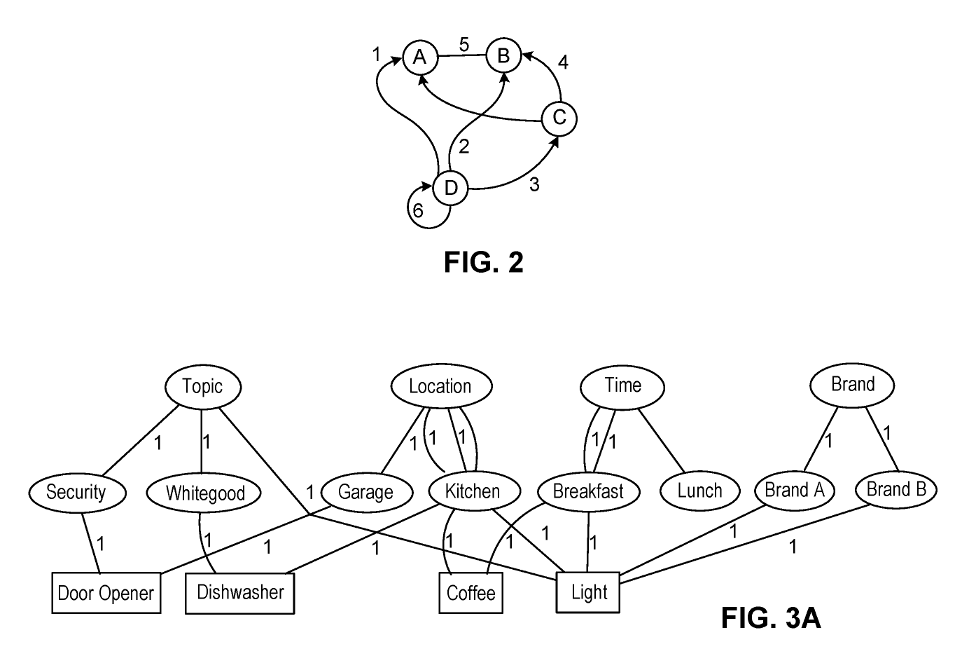

FIG. 2 illustrates an example of a user interface graph 20 for a user interface that has four potential screens (A, B, C, D). From screen D, for example, there are four possible interactions. Interaction 1 causes screen A to be displayed; interaction 2 causes screen B to be displayed; Interaction 3 causes screen C to be displayed; and interaction 6 does not change the screen (i.e., screen D continues to be displayed).

Each node is associated with one or multiple types. For example, a node can be time based (e.g., morning, afternoon), location based (kitchen, garage), brand based (Brand A, Brand B), topic based (e.g., lighting, security, audio/video, temperature, windows & doors). Nodes of similar types are compatible for the purpose of potentially merging them on the same screen of the app.

Each edge of the user interface graph 20 has a corresponding duration. In general, it can be assumed that the shorter the edge duration, the better the user interface. The total edge duration refers to the time it takes for a user to execute an interaction on a given screen after the user decides to interact in a particular way (i.e., this include the idle time (ti)). This duration thus depends on the previous nodes visited as well as the next node visited (tt=f(n; .3 . . . n; .1.n, .n,·1)). The total edge duration can be considered a combination of the following times: (i) an orientation time (t) that represents the time to understand the options available on a screen; (ii) a decision time (td) that represents the time it takes the user to decide what he wants after he understands what options are available on the screen; (iii) a search time (ts) that represents the time it takes to find the desired interaction on the screen after the user decided want he wants; (iv) an execution time (to) that represents the time it takes the user to execute the desired interaction.

A path represents a sequence of interactions and screens that leads the user to a desired interaction. The path duration (tpath) represents the sum of all total edge durations along the path:

$${t}_{path} = {\sum }_{i = 0}^{q} {t}_{i}$$

The fastest path can be considered the path that minimizes the sum of all interactions along the path.

In addition to the user interface graph 20 of the user interface 14, an intuitive relationships graph 22 can be stored (e.g. in the cloud or on the device itself 10) and models intuitive relationships between certain interactivity events of one or more users. In this case, nodes represent interaction events such as an interface input or output, and edges represent an intuitive relationship between two interaction events. Each edge has a property that represents the normalized strength of the relationship (e.g., how often does the relationship occur during normal user behavior). The intuitive relationships graph 22 is orthogonal to a specific user interface graph 20. Thus, the nodes and edges in the intuitive relationships graph 22 can have different meanings from those in the user interface graph 20. Whereas the user interface graph 20 describes the possible set of screens and possible user interactions, the intuitive relationships graph 22 represents intuitively related interactions. In some cases, the distance between two interaction nodes in the user interface graph 20 can be relatively large (e.g., many nodes separating the two interaction nodes), whereas the same nodes may be adjacent one another in the intuitive relationships graph 22.

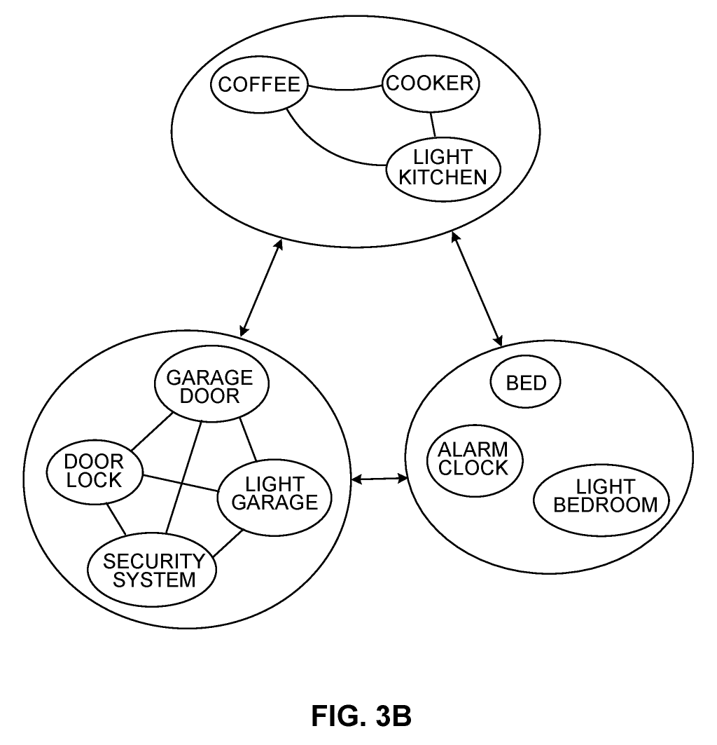

FIGS. 3A and 3B illustrate examples of intuitive relationships graphs. The example of FIG. 3A shows clusters around topics of interactions, locations of interactions, times of interactions, and brands of interactions. Some nodes can be intuitively merged (e.g., a Brand A light bulb and a Brand B lightbulb), whereas others cannot. A node can be time-based (e.g., morning, afternoon), location-based (kitchen, garage), brand-based (Brand A, Brand B), topic-based (e.g., lighting, security, audio/video, temperature, windows & doors). The graph also presents a cluster around “kitchen” with two interactions impacting “coffee” and “light.” In general, the intuitive relationships graph 22 will be relatively static, as it is based on input from a lot of user data. The intuitive relationships graph can include information indicative of the distance, or strength of the relationship, between different activities. The example graph of FIG. 3B, for example, indicates that intuitively the user would want to turn on the kitchen light and make coffee. Thus, the distance between turning on the kitchen light and making coffee would be represented, in this example, by a relatively small distance (e.g., 1). Events for which the relationship is deemed to be weaker (e.g., turning on the garage light when a bedroom alarm clock goes off) would have a relatively large distance (e.g., 3).

The intuitive relationships between interactions in the intuitive relationships graph 22 can be reflected by user actions or user thoughts. For example, a user thoughts graph 24 reflects intuitive relationships between interactivity events that are not measured by actions. Although user thoughts cannot be measured directly, they can be implied indirectly. For example, a thoughts cluster may contain all lights in a house together in one menu, even though any two lights do not necessarily have to be part of the same action cluster (e.g., the user may rarely, if ever, turn on the lights in the living room and bedroom at the same time). User thoughts can be determined implicitly by presenting alternative user interface screens and measuring the interaction durations of these interface screens with respect to the desired actions.

Likewise, a user action graph 26 represents user thoughts that are reflected in actual user actions. (e.g., a user almost always turning on the kitchen light before making coffee). Such actions can be measured directly. The clusters can be identified and used to help optimize the user interface graph 20. User action graphs 26 also can be used to predict a user's potential next actions to improve the efficiency of the user interface graph 20 even further.

In the illustrated example, whenever adjacent events occur, the intuitive relationship between the nodes in the user action graph 26 is incremented by one. The resulting graphs have clusters of intuitively related actions that should be adjacent in the user interface graph 20. Each edge in the graph can have an associated count of how often the adjacent events occur together. At times, events will be executed adjacently even though they are not intuitively related (e.g., a garage door opening and making coffee). A threshold value can be used to eliminate edges that are below the threshold value, thereby creating clear clusters of activities that intuitively belong together.

A cluster graph can be created by the habits of a single user or multiple users (i.e., multiple users that belong to a certain group). Further, a user can belong to multiple groups. For example, a certain person serving in the capacity of an employee of a company may have a very different cluster graph than the same person serving in the capacity of a resident of a smart home.

Seeding graphs 28 for the user interface graph 20 also can be stored (e.g., in the cloud) and represent initial graphs from the universe of potential user interface graphs that are used as seeds to allow the process to identify the optimum user interface. Examples of seeding graphs 28 include: a fully connected graph, a base graph and an empirical graph. The fully connected graph represents a single screen from which every interaction can be reached. Typically, a fully connected screen is not the optimal user interface. The base graph represents a graph that is modelled as if the different apps are downloaded and used in traditional ways. The empirical graph represents a graph is created as the result of multiple iterations from many user habits.

A seeding graph 29 for the user thoughts graph 24 also can be stored (e.g., in the cloud) and represents various human intuitive relationships between interactivity events that are inherent to humans and are not very dynamic. For example, a person who seeks a certain type of product may begin by looking for products of a certain brand. Although the user thoughts graph 24 is mainly seeded (i.e., it is not dynamically created), path tracing allows the process empirically to measure the performance of traces compared to the ideal traces (using the duration times). After repeated swaps over an extended period of time, new user thought clusters can be identified that are not reflected by action clusters. This effect can be accelerated by combining the results of multiple users instead of measuring the effect of a single user over a longer period of time.

A computing system 30, which can include, for example, one or more cloud servers or other servers, executes a process that attempts to minimize the gap between distances in the user interface graph 20 and the intuitive relationships graph 22. Interaction nodes in the intuitive relationships graph 22 can, in some cases, belong to multiple clusters and, therefore, an actual user interface graph generally will be the result of complex tradeoffs.

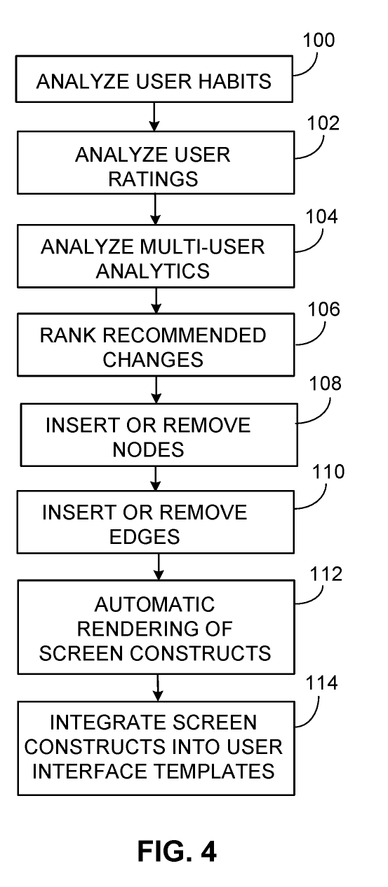

FIG. 4 illustrates an example of a method executed by the server system 30, which analyzes user habits (100), analyzes user ratings (102) and analyzes multi-user analytics where applicable (104). The process ranks recommended changes (106), inserts and/or removes nodes of the user interface graph 20 (108), and inserts and/or removes edges of the user interface graph 20 (110). The server system 30 can include a user interface graph efficiency engine 37 that implements these aspects of the process. The process then renders screens constructs based on the modified user interface graph (112) and integrates the screen constructs into user interface templates (114). The server system 30 can include a rendering and integrating engine 38 that is operable to render the screen constructs and integrate the screen constructs into the user interface templates. In this example, input data can be provided to the server system 30 in one or more ways. Data relating to user habits can come from one user or multiple users.

Feedback as to user satisfaction can come from implied sources (e.g., frustration metrics, such as a user repeatedly going back and forth between screens along the path) or explicit sources (e.g., express ratings of the user interface). Thus, in some cases, performance of the user interface can be measured based, at least in part, on the number of times a user moves back and forth between same nodes of the user interface graph. A higher number of times the user moves back and forth may be indicative of poor performance of the user interface. In some instances, performance may be measured based, at least in part, on an amount of time a user takes to engage in a sequence of interactions until the sequence is completed. Shorter times can be indicative of an effective interface. In some implementations, hovering of a mouse pointer can be interpreted as indicative of user confusion, and, in response, the quality score of the user interface can be reduced. Some aspects of the user interface may be prioritized based on frequency of use. In some instances, machine learning techniques can be applied to improve the interactive user interface.

The server system 30 can perform input/output (“I/O”) extraction and control in any one of several ways. For example, I/O extraction and control can occur through a specific application program interface (“API”), in other words, a set of routines, protocols, and tools for building software applications. In some implementations, I/O extraction and control can occur by executing the apps in the cloud and having one interface app downloaded on the smart phone or other device 10. In such cases, the interface app controls the applications executing in the cloud. In yet other implementations, I/O extraction and control occurs by executing the apps running in hardware in the product and having one interface app downloaded on the smart phone or other device 10. In such cases, the interface app controls the applications executing in the hardware.

In some implementations, a generic markup language is used to convert the user interface graph into an actual user interface that can be executed by a computer system. In some cases, a compiler reads the markup language and creates computer code to render the actual user interface. The interface constructs can be generalized and defined.

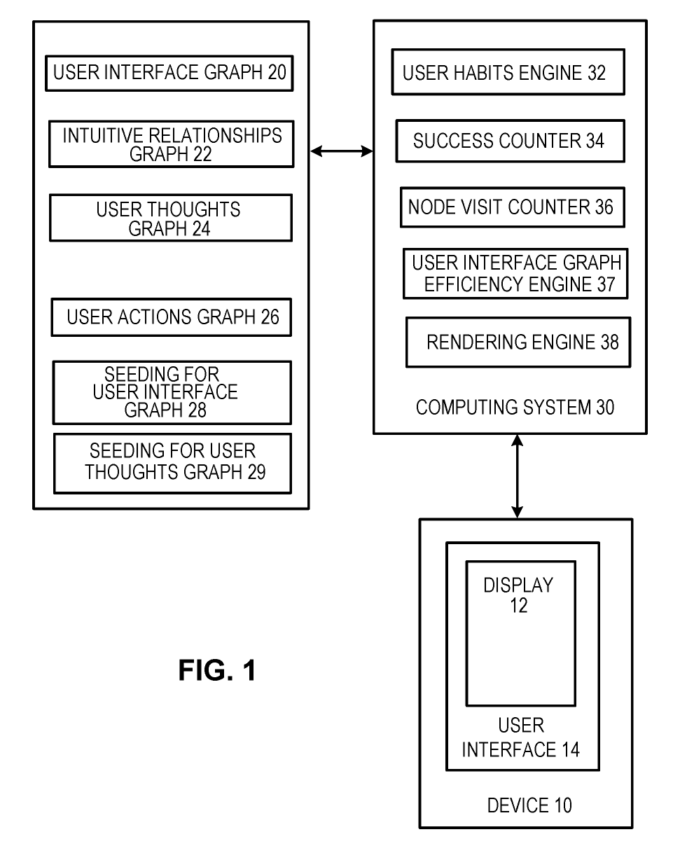

As shown in FIG. 1, a user habits monitor engine 32 is operable to track various performance metrics during functional use of the system. A graph data structure can be used to keep track of the various user habit metrics. For example, each navigation or interaction node can have a success counter 34 operable to keep track of how many times the node was part of a successful event. The success of any event can be assessed in one of several ways.

The user interface session starts (session initiation) from the moment when the user turns on the user interface (e.g., by opening an app or touching the screen of the smart phone or other device 10). After the user initiates the session, the user may provide inputs that direct the app along a particular path (path initiation). A session can have multiple paths. In this context, a new path is defined by the user having a new objective, and the path initiation event occurs when the user starts deploying the user interface 14 for a certain goal. The initiated path will either terminate through success, failure, or a timeout.

Path termination refers to the event where the user has (1) a successful interaction that meets the user's initial intent, (2) a failure to meet the user's intent, or (3) a timeout such as where the user simply stops interacting with the user interface (e.g., screen turns off after not being deployed for a predetermined period of time).

A success event occurs when a user has executed an interaction, and the respective node that leads to the execution was successful. As noted above, each node has an associated success counter 34 to reflect the number of times a respective node (e.g., screen) leads to a success event. On the other hand, a frustration event occurs when the user habits monitor engine 32 adds information to the edges of the graph to reflect non-ideal behavior, such as a user going back and forth between screens without actually executing an interaction. Such behavior may be indicative of a confusing interface architecture.

The process monitors the user interactions of a path from screen to screen using, for example, a graph coloring algorithm in which each node of the user interface graph has a visit counter 36 whose value is incremented each time the node is visited. A temporary edge duration time can be averaged after each visit. This average represents a temporary storage because the durations make sense only if the path was successful. Edges should not be considered favorable if a user can use them to lead to nodes along paths that do not help the user reach his desired goal. When there is a success event, the process also determines an ideal path.

Once an actual path within the app is completed, the process assigns an additive score to the nodes of the path to reflect the contribution of each node and interaction that led to the successful event. For example, nodes that were visited multiple times to get to success can be assigned a relatively low score. The various counts then can be added to the success count 34 for that node. On the other hand, a failure may represent, for example, a time-out or change in user intent (e.g., an implied event that is the result of statistical analysis). The various counts then can be subtracted from the success counter 34 for that count.

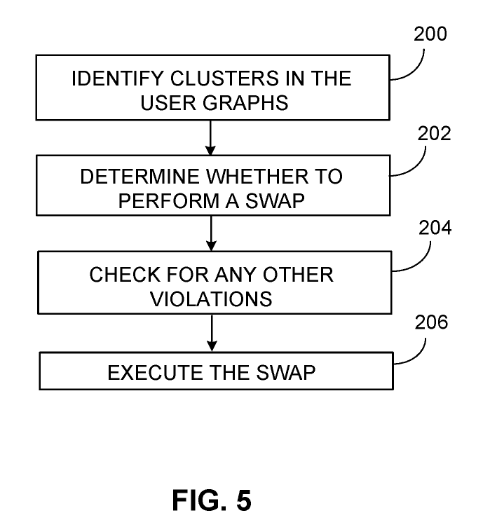

FIG. 5 illustrates an example of a process for calculating the efficiency of a user interface graph 20. Given a certain user graph (e.g., a user actions graph 26 or user thoughts graph 24), the process can calculate the effectiveness of a certain interface graph as follows. First, the process identifies clusters in the user graphs (200). This step can include eliminating edges of the graph if the edges have an edge strength below a specified threshold. Across all potential swaps of two interactivity nodes in the interface graph, the process determines whether to perform a swap (e.g., a modification such as pruning/eliminating an edge; collapsing/combining multiple edges into a single edge; or expanding an edge into multiple edges) by determining whether the swap reduces non-ideality (202), where non-ideality equals the difference between the absolute value distance (“SUM”) of one permutation in the user graph and the distance of the same permutation in the user interface graph 20. If the swap reduces the non-ideality, then it checks for any other violations (204). If there no other violations, the process executes the swap (206). The user interface graph efficiency engine 37 can be used to implement these aspects of the process. The various engines (e.g., 32, 37, 38) can be implemented, for example, as part of the computer system 30, and can include hardware as well as software.

The speed of the process can be increased, for example, by using the path tracing algorithms and comparing the actual path to the optimal path after success. The gaps (i.e., difference in distances) can serve as a prioritization vehicle of what swaps the process should try first.

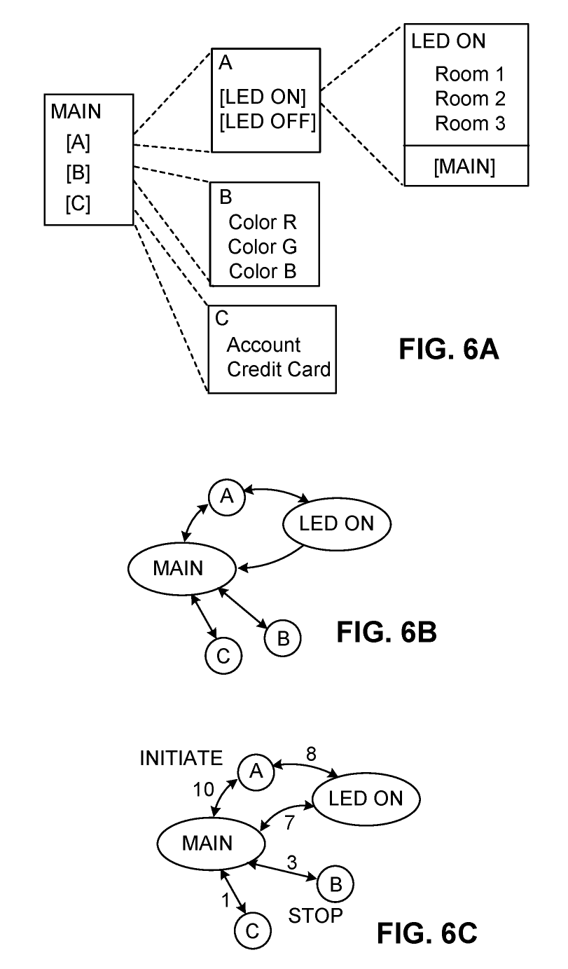

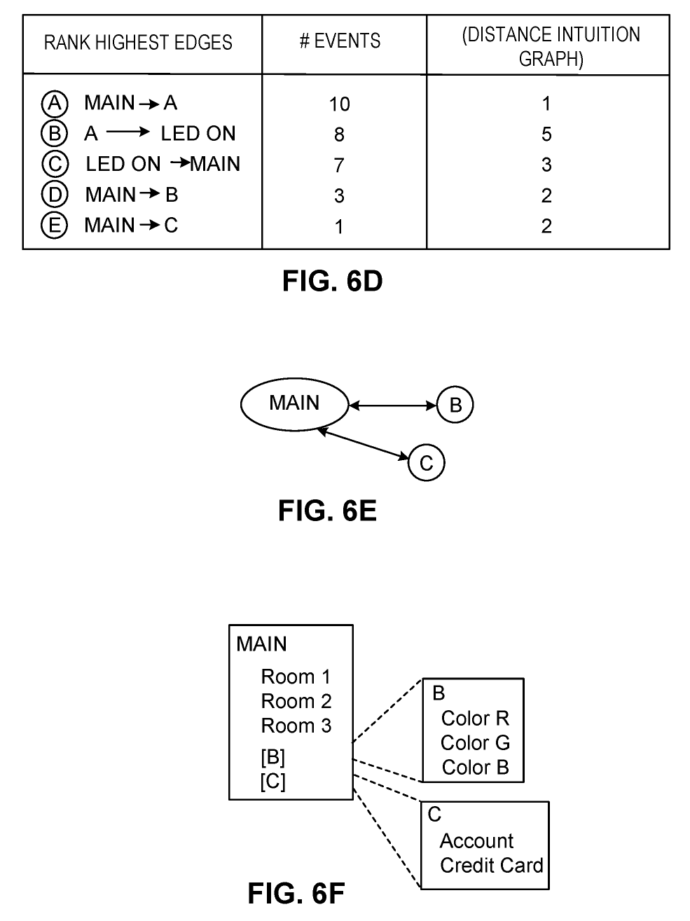

FIGS. 6A-6F illustrate an example of the foregoing process. As shown in FIG. 6A, an initial user interface model includes five nodes, each of which represents a different screen displayed by an app. A MAIN screen allows a user to select from options [A], [B] and [C]. When a user selects one of the options, the app causes a different corresponding screen to be displayed on the device 10. For example, selection of option [A] cause a screen A to be displayed. Screen A allows the user to select from the following two options: [LED ON] and [LED OFF]. Selection of option [LED ON] causes the app to display another screen from which the user can select for several rooms (e.g., ROOM1, ROOM2, ROOM3) to turn on the lights. The user also can select an option the causes the app to return to the MAIN screen. If the user selects option [B] from the MAIN screen, the app causes a screen B to be displayed from which the user can select a color of the lighting (e.g., R=red; G=green′ B=blue). Further, if the user selects option [C] from the MAIN screen, the app causes a screen to be displayed where the user can enter account and credit card information. FIG. 6B is user interface graph that includes modes and edges representing the potential paths available through the app of FIG. 6A.

As a user navigates the app and traverses various paths during a session, the process implemented by the computing system 30 monitors and tracks the number of times the user traverses each edge in the user interface graph of FIG. 6B. The tracking can continue so long as the user is engaged with the app or until there are no user interactions for more than a predetermined duration. For example, FIG. 6C shows a copy of the user interface graph of FIG. 6B with indications of the number of times each edge was traversed during the session.

As shown in FIG. 6D, the edges of the user interface graph can be ranked, for example, based on the number of times the user traversed each edge. Based, at least in part on such rankings, the process determines which (if any) of the nodes and edges of the graph should be pruned/eliminated, collapsed/combined, and/or expanded. In order to confirm that such modifications make sense to implement, the process can compare the rankings to distances between the corresponding nodes in the intuitive relationships graph 22, as indicated by FIG. 6D. Assuming the proposed modifications are consistent with (or not contradicted by) the information in the intuitive relationships graph 22, the process proceeds to implement them. Thus, in the illustrated example, the process determines that the LED ON screen and the A screen should be merged with the MAIN screen, thereby effectively eliminating the two edges from the user interface graph. FIG. 6E illustrates the new user interface graph based on the user habits. The process then automatically renders the screen constructs and integrates the screen constructs into user interface templates that correspond to the modified user interface graph. FIG. 6F shows the modified app screens for this example. When the user initiates another session using the app, the modified set of screens are displayed.

In some implementations, the process can make available different user interfaces (e.g., different potential paths of app screens) that vary for different time periods for a particular user. Thus, during the morning hours, for example, the user interface may make available one set of potential paths and screens, whereas during the afternoon or evening hours, the user interface may make available a different set of potential paths and screens. Of course, there may be at least partial overlap between the user interfaces for the different time periods. Likewise, different user interfaces may be applicable for different days of the week or different times of year. In each case, the user interface can be based on the user's past habits in using the app.

The processes and systems described here can allow dynamic, on-the-fly optimization of an app's user interface based on the particular individual user's habits or based on the habits of a particular group of users. The app's user interface thus can be customized so that the screens displayed for the resulting user interface differ from one user (or group of users) to the next. The habits of groups of users can be monitored and analyzed together, for example, in the context of employees of the same company or members of a single household. In such situations, it may make sense to modify the app's user interface by taking into consideration all members of the group collectively, rather than modifying the app's user interface for each user individually.

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the claims.

What is claimed is:

1. A method comprising:
monitoring, by a computing system, user interactions with an application operable to present an interactive user interface;
automatically modifying, by the computing system, a model of the interactive user interface based on the monitoring;
automatically rendering, by the computing system, screen constructs based on the modifying; and
automatically integrating, by the computing system, the screen constructs into user interface templates for presentation during a subsequent user session with the application.

2. The method of claim 1 wherein the model of the interactive user interface is a directed graph composed of nodes and edges.

3. The method of claim 2 wherein modifying the model includes eliminating one or more of the edges.

4. The method of claim 2 wherein modifying the model includes combining multiple ones of the edges into a single edge.

5. The method of claim 2 wherein modifying the model includes expanding one of the edges into multiple edges.

6. The method of claim 1 including presenting, during the subsequent user session, a modified user interface based on the screen constructs integrated into the user interface templates.

7. The method of claim 1 including customizing the user interface for the particular user.

8. The method of claim 2 including monitoring performance of the user interface and seeking pathways along the directed graph for improved performance.

9. The method of claim 8 wherein the performance is measured based, at least in part, on a number of times a user moves back and forth between same nodes of the user interface, wherein a higher number of times the user moves back and forth is indicative of poor performance of the user interface.

10. The method of claim 8 wherein the performance is measured based, at least in part, on an amount of time a user takes to engage in a sequence of interactions until the sequence is completed, wherein shorter times are indicative of an effective interface.

11. The method of claim 8 wherein aspects of the user interface are prioritized based on frequency of use.

12. The method of claim 8 including interpreting, by the computing system, hovering of a mouse pointer as indicative of user confusion, and, in response, reducing a quality score of the user interface.

13. The method of claim 2 including using a generic markup language to convert the graph into an actual user interface that can be executed by a computer system.

14. The method of claim 13 wherein a compiler reads the markup language and creates code to render the actual user interface.

15. The method of claim 14 wherein the interface constructs are generalized and defined.

16. The method of claim 8 including:
combining screens, splitting screens, or introducing new screens;
subsequently measuring the performance to determine an optimal user interface.

17. The method of claim 1 including applying machine learning to improve the interactive user interface.

18. A system comprising:
a user habits monitor engine operable to monitor user interactions with an application that is operable to present an interactive user interface;
a user interface graph efficiency engine operable to modify a model of the interactive user interface based on monitoring by the user habits monitor engine; and
a rendering and integrating engine operable to render screen constructs based on modifying of the model by the user interface graph efficiency engine, and to integrate the screen constructs into user interface templates for presentation during a subsequent user session with the application.

19. The system of claim 18 wherein the model of the interactive user interface is a directed graph composed of nodes and edges, and wherein the user interface graph efficiency engine is operable to perform at least one of the following:
modify the model by eliminating one or more of the edges,
modify the model by combining multiple ones of the edges into a single edge,
modify the model by expanding one of the edges into multiple edges.

20. The system of claim 18 operable to present on a display, during the subsequent user session, a modified user interface based on the screen constructs integrated into the user interface templates.
